(19) United States
(12) Patent Application Publication
(10) Pub. No.: US 2005/0179813 A1
(43) Pub. Date: Aug. 18, 2005

(54) Camera and electronic apparatus

(76) Inventors: Naoki Fujii, Tokyo (JP); Kaoru Kaneko, Tokyo (JP); Shinya Suzuki, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/053,348

(22) Filed: Feb. 8, 2005

(30) Foreign Application Priority Data
Feb. 18, 2004 (JP) 2004-041976

(51) Int. Cl. H04N 5/225

(52) U.S. Cl. 348/375

(57) ABSTRACT

A camera or an electronic apparatus according to the present invention has a waterproof function and comprises an outer casing for waterproofing the inside of main apparatus, a microphone and a speaker installed inside the main apparatus, openings used for sound input or sound output being featured in the outer casing at a position thereof corresponding to the microphone or the speaker, water proofing members each having a characteristic of passing air and blocking moisture and for sealing the opening from the inside, wherein the microphone or the speaker is mounted onto the water proofing member so as to let a space containing the microphone vibration plate or the speaker vibration plate communicate with only a part of space inside the main apparatus.

### CROSS REFERENCE TO RELATED APPLICATION

This application is based upon and claims the benefit of priority from the prior Japanese Application No. 2004-041976, filed Feb. 18, 2004, the entire contents of which are incorporated herein by reference.

### BACKGROUND OF THE INVENTION

1. Field of the Invention

The present invention relates to a camera or an electronic apparatus having a waterproof structure.

2. Description of the Related Art

There is a well known waterproof stereo microphone which is fixedly mounted in a sport pack used for storing a video camera, given a stereo effect, miniaturized and sensitized. (e.g., refer to a Japanese patent laid-open application publication 06-086124)

While a microphone and a speaker are generally used as a pair, likewise the above described microphone has a waterproof speaker well known as a piezoelectric sounding body which is structured not only to prevent water drops or moisture from seeping into the body when a cordless phone or a mobile phone is used in a water splashing or high humidity environment such as a hot bath room or a rest room but also to reduce a deterioration of sound pressure associated with water proofing (e.g., refer to a Japanese patent laid-open application publication 06-098497).

As for waterproofing, not only the above mentioned cordless phones and mobile phones, but also other hand held equipment such as wrist watches, cameras, et cetera, with waterproof structures are very well known. Speaking of waterproofing a camera, it is basically structured for shielding what is inside from the outside, and therefore a difference in pressure between the inside and the outside, resulting from moving the lens equipped inside the camera body, increases the load for driving the lens. a well known solution to the problem is to install a small air hole in a camera (e.g., refer to a Japanese patent laid-open application publication 2001-110376).

Meanwhile, for a digital camera in which there is no need to move the lens, a known technique is to equip an air hole in a camera body to let out gas to prevent the gas emitted by the battery from filling up the camera body and contaminating wiring for the electronic circuit (e.g., refer to a Japanese patent laid-open application publication 2001-110376).

Meanwhile, another solution is known in which an air hole is equipped near the flange of a speaker in the wall on which the speaker is mounted inside an apparatus covered with a waterproof sheet (e.g., refer to a Japanese patent laid-open application publication 06-066191).

Meanwhile, there is also a known application in which an air hole is equipped in the side nearby a suspension for a speaker which is installed in the inside of a waterproofed space (e.g., a Japanese patent laid-open application publication 08-079866)

### SUMMARY OF THE INVENTION

First of all, a camera according to the present invention, which is a waterproof camera having a lens unit including a moving lens, comprises an outer casting member for waterproofing the inside of the camera, a microphone positioned in the inside of the camera, a first opening used for a sound input which is featured in the outer member at a position thereof corresponding to that of the microphone, and a first waterproofing member having a characteristic of passing air and blocking moisture and for covering the first opening from the inside, wherein a microphone flange being featured in the microphone so as to embrace a vibration plate of the microphone and for contacting with waterproof inside wall of the camera, and a communication unit being featured in a location where contact is between the microphone flange and the waterproof inside wall of the camera so as to let a space containing a vibration plate of the microphone and the first waterproofing member communicate with only a part of space inside the camera.

In addition, a camera according to the present invention, which is a waterproof camera having a lens unit including a moving lens, comprises an outer casting member for waterproofing the inside of the camera, a speaker positioned in the inside of the camera, an opening used for a sound output which is featured in the outer member at a position thereof corresponding to that of the speaker, and a waterproofing member having a characteristic of passing air and blocking moisture and for covering the opening from the inside, wherein a speaker flange being featured in the speaker so as to embrace a vibration plate of the speaker and for contacting with the waterproof inside wall of the camera, and a communication unit being featured in a part of contacting place between the speaker flange and the waterproof inside wall of the camera so as to let a space containing a vibration plate of the speaker and the water proofing member communicate with a part of space inside the camera.

Secondly, an electronic apparatus according to the present invention, which is a waterproof electronic apparatus, comprises an outer casting member for waterproofing the inside of the electronic apparatus; a microphone being installed in the inside of the electronic apparatus; a first opening used for a sound input being equipped in the outer casting member at a position thereof corresponding to that of the microphone; and a first waterproofing member having a characteristic of passing air and blocking moisture and for covering the first opening from the inside, wherein a microphone flange being featured in the microphone so as to embrace a vibration plate of the microphone and for contacting with the waterproof inside wall of the camera, and a communication unit being featured in apart of contacting place between the microphone flange and the waterproof inside wall of the camera so as to let a space containing a vibration plate of the microphone and the first water proofing member communicate with only a part of space inside the electronic apparatus.

In addition, an electronic apparatus according to the present invention, which is a waterproof electronic apparatus, comprises an outer casting member for waterproofing the inside of the electronic apparatus; a speaker being installed in the inside of the electronic apparatus; an opening used for a sound output being equipped in the outer casting member at a position thereof corresponding to that of the speaker; and a waterproofing member having a characteristic of passing air and blocking moisture and for covering the opening from the inside, wherein a speaker flange being featured in the speaker so as to embrace a vibration plate of the speaker and for contacting with the waterproof inside wall of the camera, and a communication unit being featured in a location where contact is between the speaker flange and the waterproof inside wall of the camera so as to let a space containing a vibration plate of the speaker and the second waterproofing member communicate with only a part of space inside the electronic apparatus.

### BRIEF DESCRIPTION OF THE DRAWINGS

FIG. 1A is an external perspective view of the front of a digital camera according to a first embodiment; and FIG. 1B is the rear view thereof;

FIG. 2 is an exploded frontal perspective view of summary internal structure of a digital camera;

FIG. 3 is an exploded rear perspective view of a part of summary internal structure of a digital camera;

FIG. 4 shows a configuration of a speaker and its mounting part in a digital camera;

FIG. 5 shows a configuration of a microphone and its mounting part in a digital camera.

### DESCRIPTION OF THE COMPONENTS

1 digital camera (camera)
2 main outer casing of camera
2a front cover unit
2b center cover unit
2c rear cover unit
3a connector cover
3b battery cover
4 objective lens barrel
5 objective lens
6 lens barrier
7a, 7b slide groove
8 release switch operation button
9 microphone opening part
11 finder eyepiece
12 LCD panel window
13 X-Y operation buttons
13a positioning hole
14 zoom button
15 LCD monitor/play button
16 OK/Menu button
17 speaker opening part
18 strap mounting part
20 lens barrel assembly unit
21 PWB middle frame unit
22 front cover panel
23 objective lens opening part
24 front panel opening
25 strobe flash window
26 finder window
27 self-timer LED window
28 remote control window
29a, 29b lens barrier mounting paths (chain lines each ending with an arrow)
31 front opening waterproof sheet
32 front opening waterproof sheet mounting path (dotted line ending with an arrow)
33 strobe flash bulb
34 strobe flash unit
35 finder unit
36 front cover frame
37 microphone opening part
38 microphone opening part waterproof sheet
39 waterproof packing
40 stationary frame
41 moving frame
42 motor
43 lens drive unit
44 CCD board
45 image pickup device board
46 unit mounting plate
47 LCD unit
48 flexible PWB
49 image pickup board
50 middle frame
50a side opening edge
50b air holes
50c microphone mounting part
51 first PWB
52 second PWB
53 third PWB
54 supply battery
55 battery chamber
56 strobe capacitor
57 internal connector
58 card connector
59 video output connector terminal part
61 USB connector terminal part
62 microphone holding hole
63 microphone
64 internal cover plate
65 release button opening part
67 release switch button mounting path
68 DC connector terminal
69 speaker waterproof sheet
71 rear cover plate
72 rear cover frame
73 elastic sheet member
73a projection part
73b depression part
74 DC connector terminal opening part
75 battery insertion opening part
76 DC connector terminal cutoff part
77a back side protrusion
78 finder opening part
79 LCD opening part
81 X-Y buttons opening parts
82 monitor/play button opening part
83 OK/menu button opening part
84 cutoff part
85 zoom opening part
86 support column
87 zoom button mounting path (chain line ending with an arrow)
88 flexible PWB
89 zooming switch
91 X-Y switch
92 monitor/play switch
93 OK/menu switch
94 release switch
95 speaker positioning cut-off part
96 finder side wiring part
97 lead wire
98 terminal
99 plate member
100 flange
101 cut-off part
102 speaker
103 flange
103a flange surface
104 solid spacer
105 double adhesive tape
106 cushion
107 cut-off part
108 vibration plate
109 speaker frame
111 double adhesive sheet
112 space including speaker vibration plate
113 space inside camera
114 space outside camera
115 microphone vibration plate
116 microphone body
117 protection member
118 horizontal flange
119 vertical flange
121 space including microphone vibration plate

### DESCRIPTION OF THE PREFERRED EMBODIMENTS

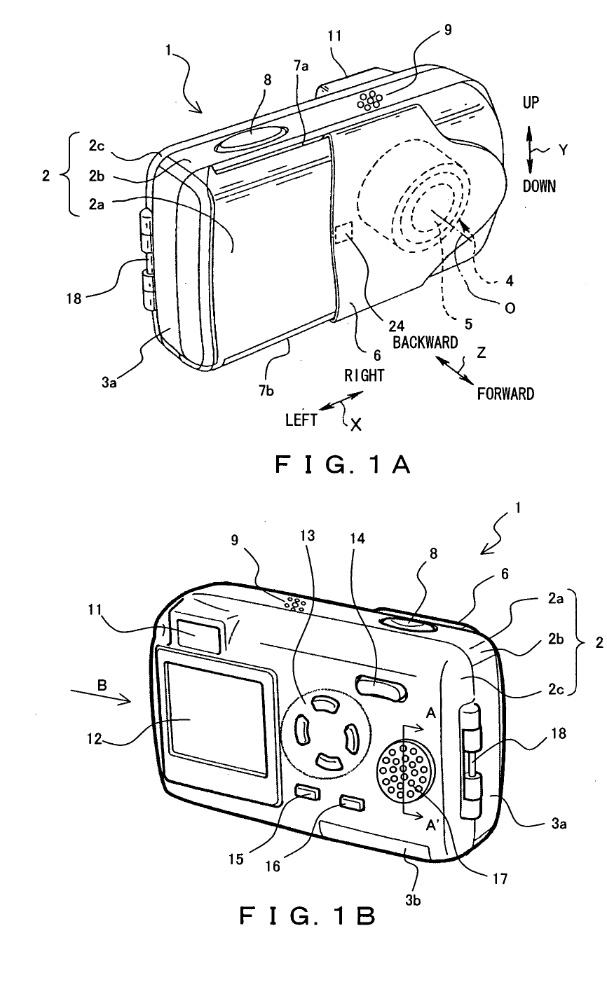

FIG. 1A is an external perspective view of the front of a digital camera according to a first embodiment; and FIG. 1B is the rear view thereof. Let it be defined that the left and right directions as shown by the double arrow-end line X in FIG. 1 for indicating the direction of the width of a digital camera are the left and right directions viewing from the object thereof in the following descriptions for the layout drawings of the digital camera 1 according to the present embodiment. Also, the front and back directions of camera shown by the double arrow-end line Z in FIG. 1 in parallel with the optical axis O of the objective lens indicate the objective side as the front while the opposite thereto as the rear; and likewise shown by the double arrow-end line Y indicates the up and down directions as those when a hand normally holds the camera.

As shown by FIGS. 1A and 1B, the whole of digital camera 1 is covered by a main outer casing of camera 2 comprising a front cover unit 2a, center cover unit 2b and a rear cover unit 2c; and a sub-casing comprising a connector cover 3a closely adjacent to the center cover unit 2b on the left side and a battery cover 3b located in a bottom part.

The front opening part of the front cover unit 2a is equipped with an objective lens barrel 4 capable of advancing and retracting in the front and rear directions. The objective lens barrel 4 holds an objective lens 5 therein, forming a movable lens unit. And, in front of the objective lens 5, a lens barrier 6 is outserted onto the front cover unit 2a, from top to bottom, across slide grooves 7a and 7b featured therein (N.B.: the slide groove 7b is on the underside and therefore it cannot be viewed in FIGS. 1A and 1B) so as to be freely slid in the right and left directions in front of the camera. The lens barrier 6 opens or closes the front opening part when the objective lens 5 is in the retracted position. In the upper part of the center cover unit 2b are equipped by a release switch operation button 8 and a microphone opening part 9. And in the back side of the rear cover unit 2c are featured with a finder eyepiece 11 and an LCD panel window 12; and equipped with X-Y operation buttons 13, a zoom button 14, an LCD monitor/play button 15 and an OK/Menu button 16. Also, a speaker opening part 17 is featured as a second opening part, behind of which is equipped with a later described speaker. Meanwhile, a strap mounting part 18 is featured on the left side of the rear cover unit 2c.

As described above, since the microphone is equipped in the top surface of main outer casing of the camera as shown by the microphone opening part 9 according to the present embodiment, it is possible to input the voice of the camera user for explanation and also pick up the voice of a person being photographed in the direction therefrom as there is no feature to shield the microphone in the front of the camera, thus making a very convenient place for equipping a microphone.

Also, since the speaker is equipped in the rear side of main outer casing, facing the camera user as shown by the speaker opening part 17 of the camera according to the present embodiment, the speaker is well located so that the camera user is able to hear a play-back sound easily.

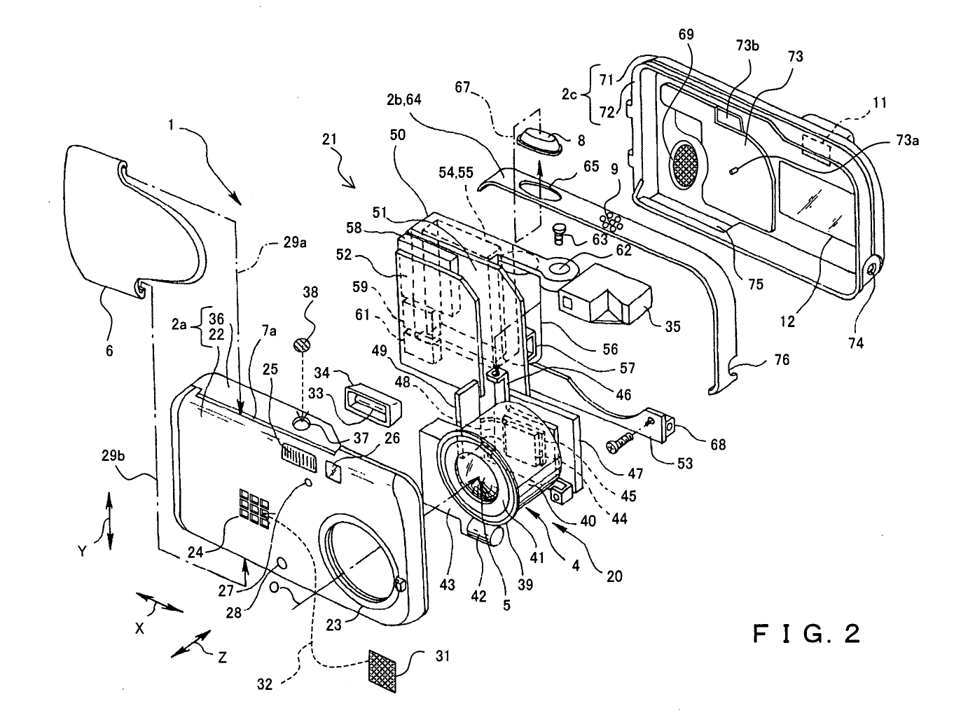

FIG. 2 is an exploded frontal perspective view of a summary internal structure of the digital camera 1. As shown by FIG. 2, the digital camera 1 comprises the front cover unit 2a, the center cover unit 2b and the rear cover unit 2c constituting the above described main outer casing 2 of the camera; the connector cover 3a (not shown here) and the battery cover 3b (not shown here) constituting the sub-casing; and the main structural members installed in the above noted casings such as lens barrel assembly unit 20 and a printed wiring board (“PWB” hereinafter) middle frame unit 21.

The front cover unit 2a comprises a front cover panel 22 made of a thin metal sheet such as aluminum, and featured with an objective lens opening part 23 being located near the right edge, a front panel opening 24 as a meshed third opening being located approximately at the center, a strobe flash window 25 as well as a finder window 26 being located side by side at the upper center, a self-timer LED window 27 immediately below the above noted two features and a remote control window 28 being located near the bottom center.

The top and bottom of the front cover panel 22, a part of the front cover unit 2a, are featured with the above noted slide grooves 7a and 7b, respectively, which extend from the left to right (N.B.: the slide 7b is on the underside and therefore it cannot be viewed in FIG. 2 as well). The aforementioned slides 7a and 7b will be outserted by the above noted lens barrier 6 as shown by the chain lines 29a and 29b so as to slide freely. The lens barrier 6 can be slid either to the closed position (i.e., to the right) for closing the objective lens opening part 23 and the strobe flash window 25 and to the open position (i.e., to the left) for opening them.

Meanwhile in the front cover unit 2a, the above noted meshed front panel opening 24 is attached by a front opening waterproof sheet 31 as a third waterproofing sheet from the backside of the front cover panel 22 as shown by the dotted line 32 ending with an arrow. The front opening waterproof sheet 31 has a characteristic of passing air and blocking moisture. The front panel opening 24 is always covered by the lens barrier independent of the position thereof and therefore it cannot be seen from the outside. Meanwhile, a strobe flash unit 34 comprising a strobe flash bulb 33 is installed in the strobe flash window 25 from the backside of the front cover panel 22. Meanwhile, in the finder window 26, a finder unit 35 containing the finder optics is installed, which is sandwiched between the finder window 26 and the finder eyepiece 11.

A front cover frame 36 made of plastic resin for assembly extends from the left end of the front cover unit 2a to the upper position thereof where the strobe flash window 25 is located and is fixed to the inside of the front cover panel 22 by using an adhesive. Toward the right end of the front cover frame 36, and at the position above the position where the strobe flash window 25 located, is featured with a microphone opening part 37 as a first opening on top of which is stuck with a microphone opening part waterproof sheet 38 as a first waterproofing sheet that has also a characteristic of passing air and blocking moisture.

Subsequently, in the above noted objective lens opening part 23 is installed by the lens barrel assembly unit 20 in which the objective lens barrel 4 is mounted onto a stationary frame 40, on which a waterproof packing 39 is attached on the outer circumference thereof, by way of a moving frame 41. The objective lens barrel 4 is supported by the stationary frame 40 so as to advance and retract freely in the direction of the optical axis O and holds the objective lens 5.

On the front lower part of the stationary frame 40 is mounted by a motor 42, while on the side thereof is equipped by a lens drive unit 43 which is driven by the motor 42 and advances and retracts the above noted moving frame 41 in the direction of the optical axis O. In the rear part of the stationary frame 40 is equipped by an image pickup device board 45 having a CCD board 44 being positioned at the focal plane of the objective lens 5, which is installed in the objective lens barrel 4, and an LCD unit 47 comprising a unit mounting plate 46 in further behind, thus making the whole part as a unit.

And the above noted LCD unit 47 is connected by an image pickup board 49 by way of a flexible PWB 48. The image pickup board 49 is also connected with a later described second PWB 52.

The above noted PWB middle frame unit 21 comprises a middle frame 50, a first PWB 51 placed closely against the side surface of the middle frame 50 opposite to the side opening thereof, a second PWB 52 placed in parallel with the first PWB 51 and a third PWB 53 placed on the outside of the first PWB 51.

The above noted middle frame 50 is featured by a battery chamber 55 inside which is covered with the first PWB 51 for installing a supply battery 54 which will be installed in the battery chamber 55 from the opening part when the battery cover 3b shown by FIG. 1 is opened. Also, the middle frame 50 are equipped with a strobe capacitor 56 for charging capacitance for strobe flashing adjacent to the battery chamber 55 and an internal connector 57 for connecting a not-shown connector of the image pickup board 49 to the first PWB 51.

The above noted first PWB 51 is a main control board on which are mounted by an image processing circuit and various control circuits. And between the first PWB 51 and the second PWB 52 installed are a card connector 58 for inserting a memory card (i.e., storage medium), a video output connector terminal part 59 and a USB connector terminal part 61 in the opening part when the connector cover 3a is opened as shown by FIGS. 1A and 1B. These parts are mounted onto the first PWB 51.

While the above noted card connector 58, video output connector terminal part 59 and USB connector terminal part 61 are exposed to the outside on the left side as shown by FIG. 2, they will be sealed from the outside by the connector cover 3a, shown by FIG. 1A, having a packing around the internal peripheral thereof when the whole camera body is assembled.

In the mean time, the second PWB 52 is mainly mounted by a supply source circuit part. And the third PWB 53 is mainly mounted by a strobe control circuit and the above noted strobe capacitor 56, and is featured with an extension being extended from the bottom thereof to the right. Close to the end of the extension is mounted by a DC connector terminal 68 and is featured by a screw hole for screw-mounting the board onto the rear cover unit 2c.

Meanwhile, the top surface of the above noted middle frame 50 is configured for extending to the center of the camera body, toward the end of which is featured by a microphone holding hole 62 that will be fitted by the lower engagement part of a microphone 63 for holding it.

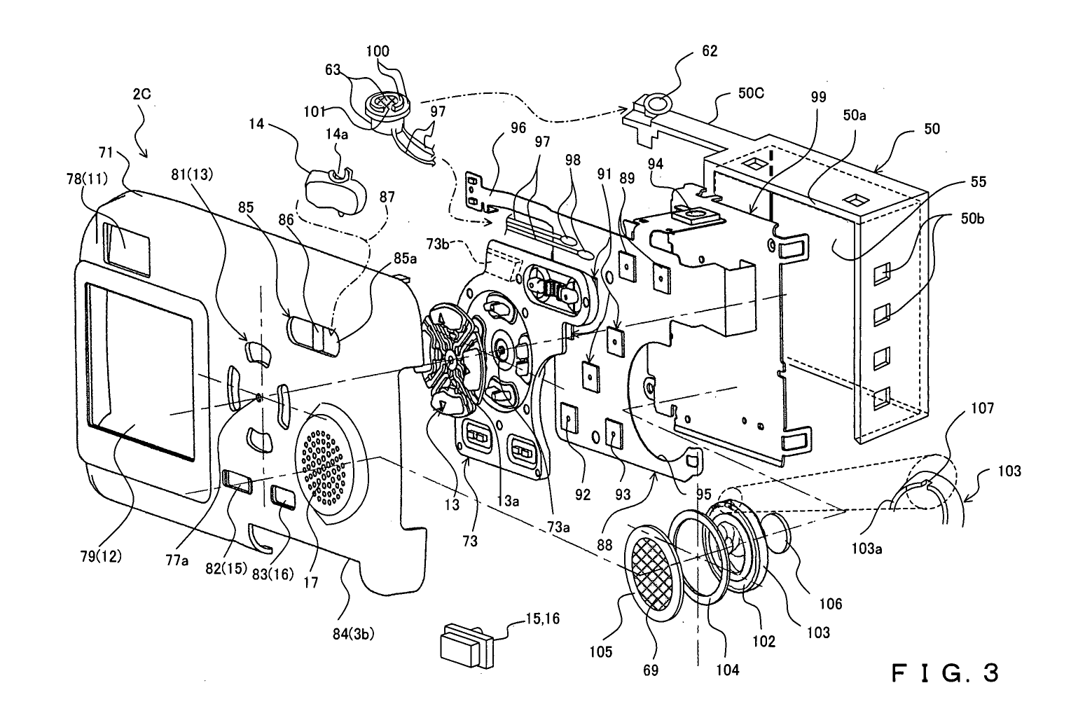

The above described configuration places the microphone 63 between the battery chamber 55 which will hold a battery tending to emit gas, and the lens part (i.e., lens barrel assembly unit 20) as well as the strobe capacitor 56 for strobe flashing both of which are associated with temperature rise when operating. However, the configuration is such that the microphone 63 is held by a microphone mounting part 50c (refer to FIG. 3) of the middle frame 50 being structured independent of the lens barrel assembly unit 20 so as to pick up a vibration of the tube frame very little associated with the lens movement, although the microphone 63 is placed adjacent to the lens barrel assembly unit 20.

Being placed between the front cover unit 2a and the rear cover unit 2c, the center cover unit 2b, covering the central upper and right sides of the aforementioned covers, comprises an internal cover plate 64 made of a sheet metal such as aluminum which are featured by a release button opening part 65 and the microphone opening part 9 as the first opening in the top part, and a DC connector terminal cutoff part 76 nearby the right low end thereof. In the release button opening part 65, the release switch operation button 8 will be inserted from below as indicated by a chain line 67.

Lastly, the rear cover unit 2c comprises a rear cover plate 71 made of a sheet metal such as aluminum and a rear cover frame for assembly 72 made of a plastic resin and fixed to the rear cover plate 71 by using an adhesive.

In FIG. 2, in the internal and side wall of the rear cover plate 71 are installed by the finder eyepiece 11 also shown by FIGS. 1A and 1B and the LCD panel window 12 to the right, while is placed by a speaker waterproof sheet 69 as a second waterproofing member toward the left bottom. Furthermore, in the center part is placed by an elastic sheet member 73 made of a synthetic elastomer being formed in a designed concave-convex shape, and the later described X-Y operation buttons 13 also shown by FIG. 1B are installed between the elastic member 73 and the rear cover plate 71.

In the center of the back side (i.e., facing the inside of the camera) of the above noted elastic member 73 are featured by a projection part 73a for pressing the X-Y operation buttons and a depression part 73b for avoiding a pressing with a later described microphone lead wire solder part around the top base of the long narrow part extending top leftward. Meanwhile, the above noted rear cover frame 72 are featured by a DC connector terminal opening part 74 in the right bottom part thereof as shown by FIG. 2 and a battery insertion opening part 75 for detachably fitting the battery cover 3b, shown by FIG. 1, in the bottom part thereof. Nearby the bottom end of the internal cover plate 64 of the above noted center cover unit 2b, a DC connector terminal cutoff part 76 is featured in correspondence with the above noted DC connector terminal opening part 74.

The above noted front cover frame 36 and rear cover frame 72 are connected, while not shown, by way of a waterproofing member being sandwiched in between and by fastening screws inserted into respective screw holes for forming an external casing of the digital camera 1 together with the above noted front cover panel 22, internal cover plate 64 and rear cover plate 71.

FIG. 3 is an exploded rear perspective view of a part of internal structure of the digital camera 1. Let it be noted here that the front cover unit 2a, the lens barrel assembly unit 20, the first through third PWBs 51 through 53, respectively, and the center cover unit 2b all shown in FIG. 2 are omitted in FIG. 3.

As shown in FIG. 3, in a rear cover plate 71, made of a sheet metal such as aluminum, of the rear cover unit 2c is featured by a finder opening part 78 for the finder eyepiece 11 shown by FIG. 1B and an LCD opening part 79 for the LCD panel window 12. When installing the finder eyepiece members and LCD panel part members in these openings, the sealing adhesive is applied to close all the gaps throughout the circumference so as to seal off moisture or humidity.

The rear cover plate 71 are further featured by four X-Y buttons opening parts 81 for the X-Y operation buttons 13, a monitor/play button opening part 82 for the LCD monitor/play button 15, an OK/menu button opening part 83 for the OK/Menu button 16, a speaker opening part 17 and a cutoff part 84 for the battery cover 3b, in addition, in the right upper part is featured by a zoom opening part 85 for the zoom button 14 which is also featured by a support column 86. All these buttons have also been shown by FIG. 1B.

The zoom button 14 is inserted into the right side of the opening 85a from the rear side while twisting the left end of the button horizontally, as shown by the chain line 87, so that the engagement part 14a engages with the support column 86 and thus the zoom button 14 can be rocked around the support column 86.

Each of the above noted button openings will be inserted by the respective button shown by FIG. 1B from behind and fixed for the respective positions from behind by the elastic sheet member 73 which is fixed with an adhesive.

In particular, the X-Y operation buttons 13 are featured by a positioning hole 13a at the center thereof. And, corresponding to the positioning hole 13a, a back side protrusion 77a, which is seen as a depression from the front surface, is featured at the central part of the four X-Y buttons opening parts 81 of the rear cover plate 71 on one hand, and a projection part 73a is featured at the center of the X-Y operation button support part of the elastic member 73 on the other.

By the above described, the positioning hole 13a of the X-Y operation buttons 13 is inserted by the back side protrusion 77a of the rear cover plate 71 from the front and inserted by the projection part 73a of the elastic member 73 from the behind, thereby positioning the X-Y operation buttons 13.

In addition to fixing the position of the elastic member 73 with an adhesive, a sealing adhesive is applied along the outer circumference of the elastic member 73 without leaving a gap. This will prevent moisture or humidity seeping into the gap between each button and the button hole from invading inside the camera.

Closely attached behind the elastic member 73 is placed a flexible PWB 88, between the contact surface of which and the elastic member 73 are installed two zoom switches 89 corresponding to the zoom button 14, four X-Y switches 91 corresponding to the X-Y operation buttons 13, a monitor/play switch 92 corresponding to the LCD monitor/play button 15, an OK/menu switch 93 corresponding to the OK/Menu button 16 and a release switch 94 corresponding to the release switch operation button 8 (refer to FIGS. 1A and 1B).

Meanwhile, the flexible PWB 88 shown by FIG. 3 are featured by a cutoff part 95 in the right bottom part for locating a speaker and a wiring part 96 for a finder side LED which extends from the narrow left upper part of the flexible PWB toward the farther left thereof.

Nearby the base of the extension of the wiring part 96 is installed by two terminals 98 with which two lead wires 97 of the microphone 63 are soldered. The depression part 73b (also refer to FIG. 2) of the above noted elastic sheet member 73 is equipped for avoiding a pressed contact with the soldered parts of the above noted two terminals 98 being caused by a closely contacting surface between the flexible PWB 88 and the elastic sheet member 73.

A plate member 99 is installed closely with the other side of the above noted flexible PWB 88, that is, opposite to the contacting surface with the elastic sheet member 73. The plate member 99, being contacted by the edge 50a of the side opening of the middle frame 50, forms the battery chamber 55, also shown by FIG. 2, comprising the middle frame 50 and the plate member 99. The opening part at the bottom of the battery chamber 55 will be sealed from the outside by the battery cover 3b, shown by FIG. 1B, being comprised of packing on the entire peripheral. A plurality of air holes 50b are provided in the side wall of the middle frame 50 in order to let out the gas emitted from a battery installed in the sealed battery chamber 55.

Meanwhile, the microphone holding hole 62 is provided at the end of the microphone mounting part 50c which is featured by extending the upper part of the middle frame 50 forming the battery chamber 55 as shown by FIG. 3. The microphone holding hole 62 holds the inserted microphone 63 for which the terminals of the two lead wires 97 coming out thereof are respectively soldered with the two terminals 98.

The microphone 63 further comprises a flange 100 on the mounting part in the upper part thereof. The upper surface of the flange 100 is featured with a circular ridge which has a cut-off part 101 instead of being a complete circle. This will be described later. Note that the size of the microphone 63 is magnified in the delineation of FIG. 3 for a clearer view.

Meanwhile, a speaker 102 is positioned in the speaker positioning cut-off part 95 of the flexible PWB 88. In front of the speaker 102 (i.e., the sound emitting direction of vibration plate; toward the left in FIG. 3) is equipped by a flange 103 embracing the circumference of the vibration plate, and are further installed by a solid spacer 104 being made a ring of a plastic film, et cetera, which is in close contact with the flange surface 103a of the flange 103, a speaker waterproof sheet 69 of which the outer rim is in close contact with the solid spacer 104 and a double adhesive tape 105 placed on the outer rim surface of the speaker waterproof sheet 69 opposite to the surface in contact with the above noted solid spacer 104. And the back of the speaker 102 (i.e., toward the right in FIG. 3) is attached by a cushion 106 and the later described double adhesive sheet. The speaker waterproof sheet 69 is fixed onto the inner surface of the rear cover plate 71 by a double adhesive tape 105.

Note that the above noted flange 103 is not a complete circle but is featured by a small cutoff 107 which will be described later.

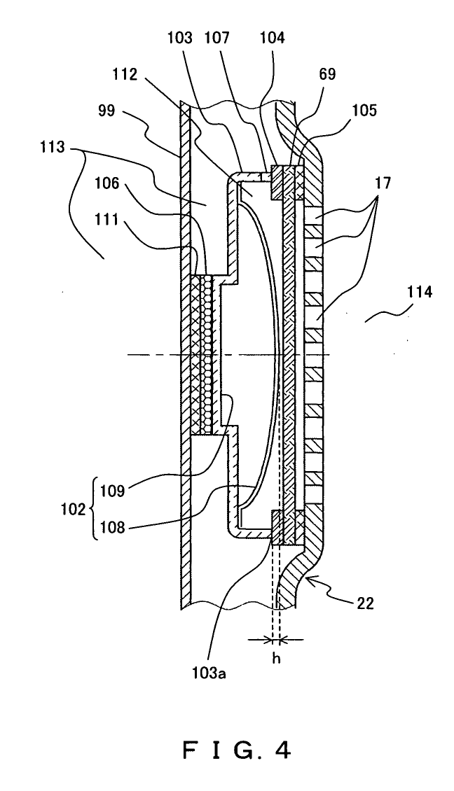

FIG. 4 shows a configuration of the above noted speaker 102 and its mounting part, showing a cross sectional view A-A′. Let it be noted that the same component numbers are given in FIG. 4 as FIGS. 1 through 3 where the configurations are the same as FIGS. 1 through 3.

As shown by FIG. 4, the speaker 102 comprises a speaker vibration plate 108 and a speaker frame 109 for supporting the speaker vibration plate 108. The outer circumference of the speaker frame 109 is integrally formed with a vertically featured flange 103 whose surface 103a (also refer to FIG. 3) is pressingly contacting with the speaker water proof sheet 69 near the outer circle of the back surface by way of the solid spacer 104. The back surface of the speaker frame 109 is fixed onto the plate member 99 by a double adhesive sheet 111 by way of a cushion 106.

This makes the whole speaker part stationary fixed between the rear cover plate 71 and the plate member 99. Even if there is a burr on a part of the flange 103 of the press-formed speaker frame 109, a resultant damage in the speaker waterproof sheet 69 can be avoided because the frame is pressingly contacting with the speaker waterproof sheet 69 by way of the solid spacer 104. Meanwhile, this layout places the speaker 102 nearby the battery chamber 55 made up with the middle frame 50 and the plate member 99.

While the circumferential end surface of the flange 103, that is, the flange surface 103a of the above described speaker 102 has to be positioned higher than the maximum height of the speaker vibration plate 108 when the solid spacer 104 is not installed, a presence of the solid spacer 104 in the present embodiment positions the flange 103a lower than the maximum height of the speaker vibration plate 108 by the height, h. Thus a consideration is given to make the whole configuration as thin as possible.

In the meantime, the normal configuration of the speaker 102 would be such that a space including speaker vibration plate 108 is enclosed by a speaker frame 109, a flange 103 and a solid spacer 104 and thus independent of a space inside camera 113, the present embodiment has the flange 103 featured by the small cutoff 107. By this, the speaker 102 is installed onto the speaker waterproof sheet 69 as a waterproofing member so that the space including speaker vibration plate 108 is in communication with the space inside camera 113 in one part only.

And the fact that the speaker waterproof sheet 69 has a characteristic of passing air and blocking moisture allows the space inside camera 113 to communicate with air in the space outside camera 114 through the speaker waterproof sheet 69, the space 112 including the speaker vibration plate 108 and the cut-off part 107 of the flange 103.

By this, when an air pressure in the space inside camera 113 becomes higher, the air inside the camera flows out to the space outside camera 114 through the cutoff 107 of the flange 103, the space 112 including speaker vibration plate 108 and the speaker waterproof sheet 69; while when an air pressure in the space inside camera 113 becomes lower, air outside the camera flows into the space inside camera 113 through the speaker waterproof sheet 69, the space 112 including speaker vibration plate 108 and the cutoff 107 of the flange 103, thus the air pressure difference will be maintained in equilibrium. Or, it is possible to exhaust gas filling inside the camera being emitted from the battery, et cetera.

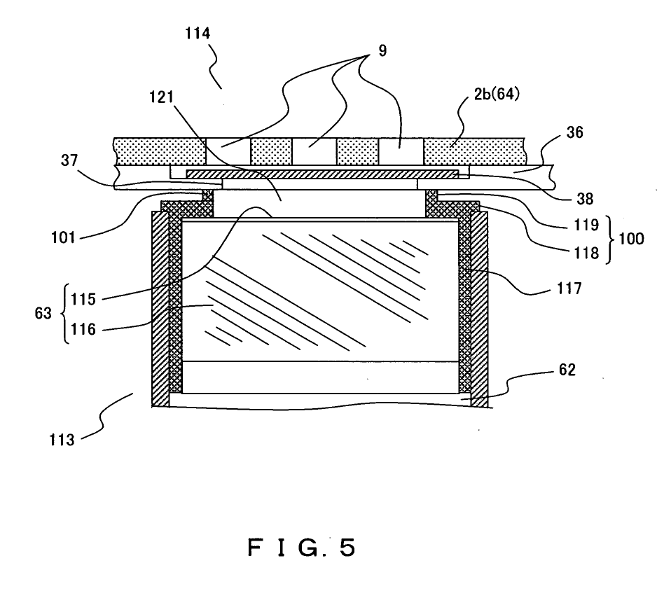

FIG. 5 shows a configuration of the above described microphone 63 and its mounting part. Let it be noted that the same component numbers are given in FIG. 5 as FIGS. 1 through 3 where the configurations are the same as FIGS. 1 through 3.

As shown by FIG. 5, the microphone 63, comprising a microphone vibration plate 115 and a microphone body 116, is protected by a cylindrical protection member 117, which is made of an elastomer material, around the outer circumference thereof and held by the microphone holding hole 62. The upper part of the cylindrical protection member 117 is integrally featured by the flange 100, also shown by FIG. 3, comprising a washer-like horizontal flange 118 and a toric vertical flange 119 extending from the inner diameter of the horizontal flange 118. The circumferential face of the vertical flange 119 is pressingly mounted onto the bottom outer peripheral surface around the microphone opening part 37 of the front cover frame 36.

As described above, the microphone opening part 37 of the front cover frame 36 is shut off on the bottom opening thereof from the inside of the camera by the flange 100 of the microphone 63, while the top opening thereof is covered by the microphone opening part waterproof sheet 38 and facing with the microphone opening part 9 featured in the internal cover plate 64 of the center cover unit 2b by way of the microphone opening part waterproof sheet 38.

In such a common configuration of microphone mounting, a space 121 including microphone vibration plate 115 would be enclosed by a flange 100 and a front cover frame 36 for a microphone 63, thus basically becoming independent of a space inside camera 113, the present embodiment, however, is configured to have a part of the vertical flange 119 of the flange 100 being featured with a small cutoff 101. By this, the microphone 63 is mounted onto the microphone opening part 37 being covered by the microphone opening part waterproof sheet 38 on the top surface so that the space 121 including microphone vibration plate 115 is in communication with a part of the space inside camera 113.

And the fact that the microphone opening part waterproof sheet 38 has a characteristic of passing air and blocking moisture allows the space inside camera 113 to communicate with air in the space outside camera 114 through the microphone waterproof sheet 38, the space 121 including microphone vibration plate 125 and the cut-off part 101 of the flange 100.

By this, when an air pressure in the space inside camera 113 becomes higher, the air inside the camera flows out to the space outside camera 114 through the cutoff 101 of the flange 100, the space 121 including microphone vibration plate 115 and the microphone waterproof sheet 38; while when an air pressure in the space inside camera 113 becomes lower, air outside the camera flows into the space inside camera 113 through the microphone waterproof sheet 38, the space 121 including microphone vibration plate 115 and the cutoff 101 of the flange 100, thus the air pressure difference will be maintained in equilibrium. Or, it is possible to exhaust gas filling inside the camera being emitted from the battery, et cetera.

Furthermore, since the microphone 63 is placed not only nearby the battery chamber 55 which tends to emit gas but also nearby the lens part (i.e., lens barrel assembly unit 20) and the strobe capacitor 56 for strobe flash both of which heat is generated in association with the operations, the above described ventilation with the outside is also well suited for heat dissipation of the lens part and the strobe capacitor 56.

As described thus far, featuring a ventilation hole by cutting off a part of flange of the speaker sounding part or the microphone voice input part and letting air communication between the inside of an apparatus and the outside eliminate an air pressure difference occurring within the apparatus and enable a smooth operation of the internal moving mechanisms according to the present invention.

Also, a plurality of ventilation holes are provided by using a plurality of components such as a speaker or microphone, eliminating a need to cut a large ventilation hole in some part and thus maintaining an integrity of appearance of a main apparatus.

Furthermore, a plurality of ventilation holes are provided by using a plurality of conventional components, eliminating a need to install a member to cover up ventilation holes for maintaining appearance, and hence making a whole main apparatus compact and ease of use.

Or, in the case of featuring an additional ventilation hole, the presence of the holes in a speaker and microphone enable the hole smaller and less visible, thus providing an integrated appearance of a main apparatus.

Also, featuring holes in a battery chamber for communicating with the internal space of the a main apparatus and a plurality of ventilation holes between the inner space of the main apparatus and the outside makes it possible to let out gas, et cetera, generated in the battery effectively and firmly to the outside, thus removing a danger of contaminating the circuit wiring.

Let it be noted here that while the description of the above described embodiment has been given for a digital camera, the present invention is not limited as such, and is of course applicable to any other camera such as a video camera, a camera unit equipped in a mobile phone or a camera unit equipped in other information processing apparatus in addition to a digital camera, and still further, to electronic equipment such as an image replaying machine having just a speaker instead of a lens unit, a PDA (personal digital assistant), a sound recording apparatus, et cetera.

1: In a waterproof camera having a lens unit including a moving lens, a camera comprising:
an outer casing member for waterproofing the inside of the camera;
a microphone being positioned in the inside of the camera;
a first opening used for a sound input being equipped in the outer casing member at a position thereof corresponding to that of the microphone; and
a first waterproofing member having a characteristic of passing air and blocking moisture and for covering the first opening from the inside, wherein the camera further comprises
a microphone flange being featured in the microphone so as to embrace a vibration plate of the microphone and for contacting with waterproof inside wall of the camera, and
a communication unit being featured in a location where contact is between the microphone flange and the waterproof inside wall of the camera so as to let a space containing a vibration plate of the microphone and the first waterproofing member communicate with only a part of space inside the camera.

2: A camera comprising:
a speaker being positioned in the inside of the camera;
a second opening used for a sound output being equipped in the outer casing member at a position thereof corresponding to that of the speaker; and
a second waterproofing member having a characteristic of passing air and blocking moisture and for covering the second opening from the inside, wherein the camera further comprises
a speaker flange being featured in the speaker so as to embrace a vibration plate of the speaker and for contacting with the waterproof inside wall of the camera, and
a communication unit being featured in a location where contact is between the speaker flange and the waterproof inside wall of the camera so as to let a space containing a vibration plate of the speaker and the second waterproofing member communicate with only a part of space inside the camera.

3: The camera according to claim 2, wherein said microphone and said speaker are installed in the upper surface of the camera and in the rear surface thereof, respectively; and
a third opening communicating with the inside of the camera, and a third waterproofing member having a characteristic of passing air and blocking moisture and for sealing the third opening from the inside, are installed in a part of said outer casing member protecting the front of the camera where said moving lens advances and retracts.

4: The camera according to claim 2, wherein said speaker is installed nearby a battery chamber.

5: The camera according to claim 1, wherein said microphone is installed between said lens unit and a strobe capacitor for a strobe flash.

6: The camera according to claim 1, wherein said microphone is positioned in the upper surface of camera and a microphone installation unit which is featured in a part of frame forming a battery chamber.

7: In a waterproof camera having a lens unit including a moving lens, a camera comprising:
an outer casing member for waterproofing the inside of the camera;
a speaker being positioned in the inside of the camera;
an opening used for a sound output being equipped in the outer casing member at a position thereof corresponding to that of the speaker; and
a waterproofing member having a characteristic of passing air and blocking moisture and for covering the opening from the inside, wherein the camera further comprises
a speaker flange being featured in the speaker so as to embrace a vibration plate of the speaker and for contacting with the waterproof inside wall of the camera, and
a communication unit being featured in a part of contacting place between the speaker flange and the waterproof inside wall of the camera so as to let a space containing a vibration plate of the speaker and the water proofing member communicate with a part of space inside the camera.

8: The camera according to claim 7, wherein said speaker flange, whose surface for mounting onto said waterproof inside wall of the camera is featured to be lower than the speaker vibration plate, comprises a ring-shaped solid spacer being sandwiched between the speaker flange and said waterproofing member so as to prevent a contact between the speaker vibration plate and the waterproofing member.

9: In a waterproof electronic apparatus, an electronic apparatus comprising:
an outer casing member for waterproofing the inside of the electronic apparatus;
a microphone being installed in the inside of the electronic apparatus;
a first opening used for a sound input being equipped in the outer casing member at a position thereof corresponding to that of the microphone; and
a first waterproofing member having a characteristic of passing air and blocking moisture and for covering the first opening from the inside, wherein the electronic apparatus further comprises a microphone flange being featured in the microphone so as to embrace a vibration plate of the microphone and for contacting with the waterproof inside wall of the camera, and a communication unit being featured in a part of contacting place between the microphone flange and the waterproof inside wall of the camera so as to let a space containing a vibration plate of the microphone and the first water proofing member communicate with only a part of space inside the electronic apparatus.

10: In a waterproof electronic apparatus, an electronic apparatus comprising:
an outer casing member for waterproofing the inside of the electronic apparatus;
a speaker being installed in the inside of the electronic apparatus;
an opening used for a sound output being equipped in the outer casing member at a position thereof corresponding to that of the speaker; and
a waterproofing member having a characteristic of passing air and blocking moisture and for covering the opening from the inside, wherein the electronic apparatus further comprises
a speaker flange being featured in the speaker so as to embrace a vibration plate of the speaker and for contacting with the waterproof inside wall of the camera, and
a communication unit being featured in a location where contact is between the speaker flange and the waterproof inside wall of the camera so as to let a space containing a vibration plate of the speaker and the second waterproofing member communicate with only a part of space inside the electronic apparatus.

11: The electronic apparatus according to claim 10, wherein said speaker is installed nearby a battery chamber.

12: The camera according to claim 3, wherein said speaker is installed nearby a battery chamber.
